(19) United States
(12) Patent Application Publication
(10) Pub. No.: US 2025/0128686 A1
(43) Pub. Date: Apr. 24, 2025

(54) ELECTROMAGNETIC PRESSURE CONTROL VALVE WITH INTERNAL COMPRESSED AIR ROUTING

(71) Applicant: Knorr-Bremse Systeme Fuer Nutzfahrzeuge GmbH, Muenchen (DE)

(72) Inventors: Friedbert Roether, Cleebronn (DE); Kai Linke, Ludwigsburg (DE); Christoph Hoffmann, Gaeufelden (DE)

(21) Appl. No.: 18/688,488

(22) PCT Filed: Sep. 5, 2022
(86) PCT No.: PCT/EP2022/074576

§ 371 Date: Mar. 1, 2024

(30) Foreign Application Priority Data
Sep. 17, 2021 (DE) 10 2021 124 136.7

(51) Int. Cl. B60T 8/36; B60T 8/50; B60T 13/68

(52) U.S. Cl. CPC B60T 8/3605; B60T 8/50; B60T 13/683

(57) ABSTRACT

An electromagnetic pressure-control-valve for controlling an air-pressure, including a housing having a compressed-air (CA) supply-connector (SC) for connecting to a CA-supply, a CA outlet-connector (OC) for connecting to a consumer, and a CA ventilating-connector (VC) for a ventilating means, and an armature supporting one valve-body (VB), first VB and second VB, on its end sides which face away from one another, and displaceable within the housing by magnetic forces counter to a spring-force of a first spring so that it connects the CA-OC selectively to the CA-SC or the CA-VC, and a first valve-seat (VS) connected to the CA-SC, and a second VS connected to the CA-VC, in which the first VB and a first VS form an inlet-valve, and the second VB and second VS form an outlet-valve. A permanent axial CA connection is provided through the first VB, the armature interior and the second VB.

### FIELD OF THE INVENTION

The present invention relates to an electromagnetic pressure control valve for controlling an air pressure in accordance with the description herein. Furthermore, the present invention also relates to a pressure control valve device for compressed air-actuated vehicle brake systems as described herein and to a compressed air-actuated vehicle brake system as described herein.

### BACKGROUND INFORMATION

An electromagnetic pressure control valve of the generic type is discussed in EP 0 433 673 B1. In this document, an axial compressed air flow is routed along an outer circumference of the armature which is guided in a bore of the housing. To this end, there either has to be a certain play between the radially outer circumferential surface of the armature and the radially inner circumferential surface of the bore, or the armature has axial grooves for the compressed air routing on its radially outer circumferential surface. In both cases, this has a disadvantageous effect on the sliding properties and stability of the movement of the armature in the bore and therefore on the wear.

Against this background, it is the object of the invention to develop an electromagnetic pressure control valve in such a way that the wear is reduced. A pressure control valve device for compressed air-actuated vehicle brake systems with at least one electromagnetic pressure control valve of this type and the compressed air-actuated vehicle brake system with at least one pressure control valve device of this type are also likewise to be provided.

This object may be achieved by way of the features of the embodiments as described herein.

### SUMMARY OF THE INVENTION

The invention proceeds from an electromagnetic pressure control valve for controlling an air pressure, with
a) a housing which has a compressed air supply connector for connection to a compressed air supply, a compressed air outlet connector for connection to a load, and a compressed air ventilating connector for connection to a ventilating means (apparatus or structure), and with
b) an armature which, on its end sides which face away from one another, in each case supports one valve body, an in particular cylindrical first valve body and an in particular cylindrical second valve body, and which can be displaced within the housing by way of magnetic forces counter to a spring force of at least one first spring, in such a way that it connects the compressed air outlet connector selectively to the compressed air supply connector or the compressed air ventilating connector, and with
c) a first valve seat which is, in particular, cylindrical and is connected to the compressed air supply connector, and with
d) a second valve seat which is, in particular, cylindrical and is connected to the compressed air ventilating connector,
e) the first valve body forming, together with a first valve seat, an inlet valve, and the second valve body forming, together with the second valve seat, an outlet valve.

In other words, the inlet valve is closed when the first valve body is seated sealingly on the first valve seat, and is open when the first valve body is lifted from the first valve seat. In an analogous way, the outlet valve is closed when the second valve body is seated sealingly on the second valve seat, and is open when the second valve body is lifted from the second valve seat.

In accordance with the invention, the following is then provided:
f) a permanent axial compressed air connection through the first valve body, through the interior of the armature and through the second valve body, which compressed air connection comprises at least one in particular cylindrical central axial through bore of the armature, at least one first axial through opening in the first valve body, and at least one second axial through opening in the second valve body,
g) the first valve body having an in particular cylindrical first radially inner portion which closes the first valve seat sealingly when the inlet valve is closed, and an in particular cylindrical first radially outer portion which has the at least one first axial through opening, and
h) the second valve body having an in particular cylindrical second radially inner portion which closes the second valve seat sealingly when the outlet valve is closed, and an in particular cylindrical second radially outer portion which has the at least one second axial through opening.

Permanent axial compressed air connection means that the axial compressed air connection is always present, regardless of whether the compressed air connection is actually flowed through by compressed air or not.

By this axially inner (in relation to the armature) compressed air connection, an outer compressed air connection around the armature with the above-described disadvantages can be avoided, as a result of which the wear of the electromagnetic pressure control valve can be reduced.

The at least one first axial through opening of the first valve body may be arranged radially on the outside in relation to the first radially inner portion of the first valve body which interacts, in particular exclusively, with the first valve seat. As a consequence, a flow connection cannot arise through the first valve seat when the first valve body is seated with its radially inner portion on the first valve seat. The first radially outer portion of the first valve body cannot close the first valve seat in contrast, because it is arranged radially outside the latter.

In an analogous way, the at least one second axial through opening of the second valve body is arranged radially on the outside in relation to the second radially inner portion of the second valve body which interacts, in particular exclusively, with the second valve seat. As a consequence, a flow connection cannot arise through the second valve seat when the second valve body is seated with its radially inner portion on the second valve seat. The second radially outer portion of the second valve body cannot close the first valve seat in contrast, because it is arranged radially outside the latter.

The permanent axial compressed air connection may conduct compressed air from the compressed air supply connector into the compressed air outlet connector, in particular, only when, in the case of an open inlet control valve, the first valve body is lifted from the first valve seat and, in the case of a closed outlet control valve, the second valve body is seated sealingly on the second valve seat. If, in contrast, the first valve body is seated on the first valve seat, that is to say in the case of a closed inlet valve, the permanent axial compressed air connection does not then conduct any compressed air.

The first valve body can also be a first separate body which is received in the axial through bore of the armature. In accordance with one development, the first axial body can be received axially displaceably in the axial through bore of the armature, for example at its first end.

The second valve body can be a second separate body and can be received, in particular, in an axially fixed and non-rotational manner in the axial through bore of the armature. In particular, the second valve body can be received in the axial through bore of the armature, for example at its second end, by way of a press fit and/or a calked connection.

The first valve body which is mounted axially displaceably in the axial through bore of the armature can particularly be supported axially on the second valve body by way of at least one second spring. As a result, a certain damping action is first of all achieved when the first valve body comes into contact with the first valve seat, which is advantageous, above all, when the electromagnetic pressure control valve is used with a relatively high switching frequency such as, for example, in order to control a brake pressure within the context of a brake slip control operation. Secondly, the axial spring force of the second spring which acts on the first valve body boosts the sealing action when the armature is forced with the first valve body against the first valve seat, for example by way of magnetic forces which bring about energization of the at least one magnet coil. Last but not least, the spring force of the at least one second spring which loads the first valve body against the first valve seat prevents the first valve body from lifting from the first valve seat as a consequence of the pressure which prevails on the first valve seat at the compressed air supply connector which, in the case of a pressure medium-actuated brake system of a vehicle, is formed by way of a brake pressure, for example.

The first valve body can also configure or support a first flexible sealing element which is made from at least one elastomer. In particular, the first valve body can consist exclusively of the first sealing element.

In accordance with one development, the first radially outer portion of the first valve body and/or the second radially outer portion of the second valve body can have radially outer slots or radially outer grooves which are arranged, in particular, distributed on the circumference, run, in particular, in the axial direction, and therefore serve for axial compressed air routing.

The outer circumferential surface of the second valve body which differs from the slots or grooves can then make contact with the radially inner circumferential surface of the axial through bore of the armature, for example by way of a press fit.

The second valve body can configure or support a second flexible sealing element which is made from at least one elastomer and seals against the second valve seat when the outlet valve is closed. In one development, the second valve body can be configured as a compressed air-permeable cage, in which the second sealing element is then held, that surface of the sealing element which points toward the second valve seat and interacts with the second valve seat being released by the cage.

In the case of the electromagnetic pressure control valve, at least one electric magnet coil can be received in the housing, it being possible for the armature to be actuated axially in a manner which is dependent on an electric excitation or de-energization of the at least one magnet coil between a first axial position, in which the second valve body seals against the second valve seat and the first valve body is lifted from the first valve seat, and a second axial position, in which the first valve body seals against the first valve seat and the second valve body is lifted from the second valve seat.

Here, the electromagnetic pressure control valve can
a) be configured as a “normally open” pressure control valve, in the case of which, when the magnet coil is not energized, the inlet valve is open and the outlet valve is closed, or
b) be configured as a “normally closed” pressure control valve, in the case of which, when the magnet coil is not energized, the inlet valve is closed and the outlet valve is open.

In the case of the “normally open” pressure control valve, the at least one first spring preloads the armature in the direction of the second valve seat in such a way that the second valve body which is arranged on the armature on the one end side is loaded sealingly against the second valve seat, and the first valve body which is arranged on the armature on the other end side is lifted from the first valve seat, the at least one magnet coil then being de-energized and, accordingly, no magnetic forces acting on the armature. In the case of an energization of the at least one magnet coil, the armature is then actuated counter to the action of the spring force of the at least one first spring in such a way that the second valve body is lifted from the second valve seat and the first valve body comes into sealing contact with the first valve seat.

In the case of the “normally closed” pressure control valve, the at least one first spring preloads the armature in the direction of the first valve seat in such a way that the first valve body which is arranged on the armature on the one end side is loaded sealingly against the first valve seat, and the second valve body which is arranged on the armature on the other end side is lifted from the second valve seat, the at least one magnet coil then being de-energized and, accordingly, no magnetic forces acting on the armature. In the case of an energization of the at least one magnet coil, the armature is then actuated counter to the action of the spring force of the at least one first spring in such a way that the first valve body is lifted from the first valve seat and the second valve body comes into sealing contact with the second valve seat.

The invention can therefore be used for both valve types, “normally closed” and “normally open”.

The invention also relates to a pressure control valve device for compressed air-actuated vehicle brake systems, which pressure control valve device is configured, in particular, such that it controls a brake pressure in a manner which is dependent on brake slip, and comprises at least one pneumatically pilot-controllable diaphragm valve. The pressure control valve device can then comprise at least one above-described electromagnetic pressure control valve, in the case of which the compressed air supply connector is connected to a device which generates the brake pressure, the compressed air outlet connector is connected to the at least one pneumatically pilot-controllable diaphragm valve for pilot-controlling the at least one diaphragm valve, and the compressed air ventilating connector is connected to a pressure ventilating means. The pressure which is controlled by the electromagnetic pressure control valve at its compressed air outlet connector can act, in particular, on a diaphragm of the diaphragm valve, in order to lift this diaphragm, for example, from a diaphragm valve seat or to load it sealingly against a diaphragm valve seat.

The invention also relates to a compressed air-actuated vehicle brake system with at least one pressure control valve device of this type.

Furthermore, the invention also relates to a vehicle, in particular a utility vehicle comprising a compressed air-actuated vehicle brake system of this type.

One exemplary embodiment of the invention will be explained in greater detail in the following description with reference to the figures.

### BRIEF DESCRIPTION OF THE DRAWINGS

FIG. 1 shows a longitudinal section through an electromagnetic pressure control valve in accordance with one exemplary embodiment in an aerating position.

FIG. 2 shows a perspective illustration of a sealing element of the electromagnetic pressure control valve from FIG. 1.

FIG. 3 shows a longitudinal section through the electromagnetic pressure control valve from FIG. 1 in a ventilating position.

### DETAILED DESCRIPTION

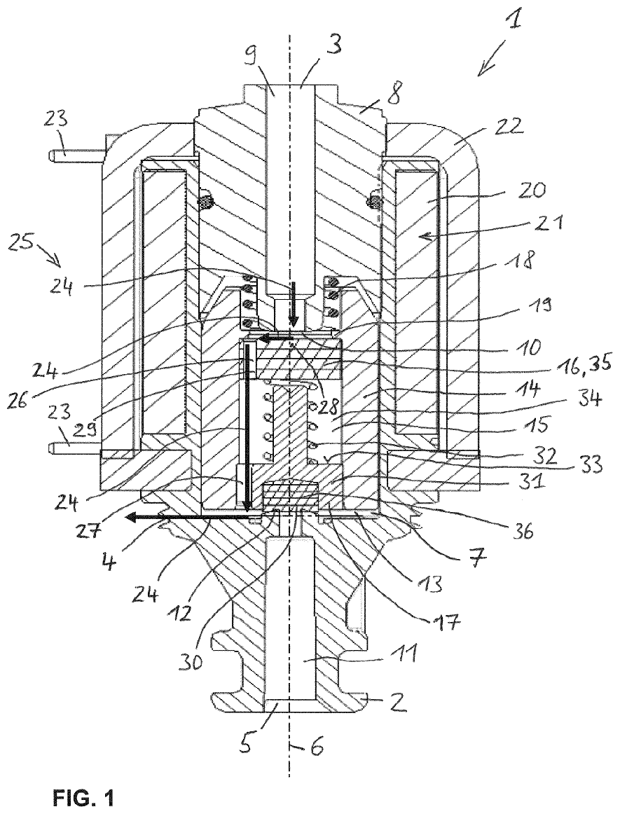

FIG. 1 shows a longitudinal section through an electromagnetic pressure control valve 1 in accordance with one exemplary embodiment in an aerating position.

The pressure control valve 1 comprises a housing 2 with a total of three connectors, namely a compressed air supply connector 3 for connection to a compressed air supply, a compressed air outlet connector 4 (not directly visible here) for connection to a load, and a compressed air ventilating connector 5 for connection to a ventilating means.

The compressed air supply connector 3 is an orifice of a stepped bore 9 which extends along a longitudinal axis 6 of the pressure control valve 1 in a cylindrical insert 8 which is received in a central blind bore 7 of the housing 2, which stepped bore 9 opens on the other end side into a first valve seat 10 which is configured in the insert 8. In relation to the longitudinal sectional illustration of FIG. 1, the compressed air outlet connector 4 is situated in a different plane of the housing 2, and is therefore not visible there. The compressed air ventilating connector 5 is an orifice of a further stepped bore 11 which runs coaxially with the longitudinal axis 6 in the housing 2 and opens on the other end side into a second valve seat 12.

In the interior, furthermore, the housing 2 has a cylindrical chamber 13 which is delimited axially on one side by an end surface of an armature 14 which is guided displaceably in the central blind bore 7 of the housing 2, and is delimited on the other side by a bottom surface of the blind bore 7 of the housing 2, in which the second valve seat 12 is also configured. The chamber 13 has a flow connection to the compressed air outlet connector 4.

Furthermore, the armature 14 has a central axial through bore 15, at the first end of which a first valve body 16 is arranged and at the second end of which a second valve body 17 is arranged, with the result that the first and second valve body 16, 17 are axially displaceable together with the armature 14 within the blind bore 7 of the housing 2. The first valve body 16 forms, together with a first valve seat 10, an inlet valve, and the second valve body 17 forms, together with the second valve seat 12, an outlet valve.

The armature 14 is preloaded here by way of the first spring 18, for example, against the second valve seat 12, which first spring 18 is supported on one side on an end surface of the insert 8 and on the other side on a radially inner collar 19 of the central axial through bore 15 of the armature 14.

Furthermore, the housing 2 configures an integral magnet coil body for securing a magnet coil 20, by it having a radially outer recess 21, in which the magnet coil 20 is wound with a plurality of windings. The radially outer recess 21 is covered peripherally by way of a separate magnet coil housing 22 which forms a constituent part of the housing 2 and has terminals 23 for current supply of the magnet coil 20, which terminals 23 are connected to the magnet coil 20.

Therefore, the armature 14 supports in each case one valve body on its end sides which face away from one another, namely the first valve body 16 and the second valve body 17. The armature 14 is then displaceable in a sliding manner in the blind bore 7 by way of the spring force of the first spring 18 and magnetic forces which come from energization of the magnet coil 20, in such a way that it connects the compressed air outlet connector 4 selectively to the compressed air supply connector 3 or the compressed air ventilating connector 5.

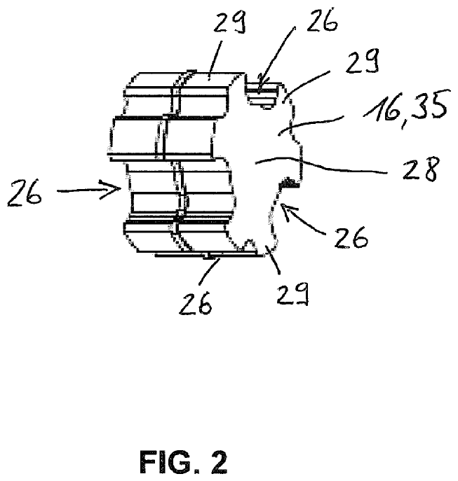

FIG. 1 shows the aerating position of the armature 14, in which the compressed air outlet connector 4 is connected to the compressed air supply connector 3, and FIG. 2 shows the ventilating position of the armature 14, in which the compressed air outlet connector 4 is connected to the compressed air ventilating connector 5, the compressed air flow being illustrated in each case by way of arrows 24.

The electromagnetic pressure control valve can
a) be configured as “normally open” pressure control valve, in the case of which, when the magnet core 20 is not energized, the inlet valve is open and the outlet valve is closed, or
b) be configured as a “normally closed” pressure control valve, in the case of which, when the magnet 20 is not energized, the inlet valve is closed and the outlet valve is open.

In the case of the “normally open” pressure control valve 1, as described here, the first spring 18 preloads the armature 14 in the direction of the second valve seat 12 in such a way that the second valve body 17 which is arranged on the armature 14 on the one end side is loaded sealingly against the second valve seat 12, and the first valve body 16 which is arranged on the armature 14 on the other end side is lifted from the first valve seat 10, in a state in which the magnet coil 20 is de-energized and accordingly no magnetic forces act on the armature 14.

In the case of an energization of the magnet core 20, the armature 14 is then actuated by way of magnetic forces counter to the action of the spring force of the first spring 18 in such a way that the second valve body 17 is lifted from the second valve seat 12, but the first valve body 16 comes into contact sealingly with the first valve seat 10.

The inlet valve is therefore closed when the first valve body 16 is seated sealingly on the first valve seat 10, and is open when the first valve body 16 is lifted from the first valve seat 10. In the case of an open inlet valve or in the aerating position of the armature 14, a flow connection is established between the pressure supply connector 3 and the pressure outlet connector 4, as a result of which the pressure at the pressure outlet connector 4 rises.

The outlet valve is closed when the second valve body 17 is seated sealingly on the second valve seat 12, and is open when the second valve body 17 is lifted from the second valve seat 12. In the case of an open outlet valve or in the ventilating position of the armature 14, a flow connection is established between the pressure ventilating connector, the chamber 13 and the pressure outlet connector 4, as a result of which the pressure at the pressure outlet connector 4 drops.

As stated above, the electromagnetic pressure control valve 1 is configured here, for example, as a “normally open” pressure control valve, in the case of which, when the magnet core 20 is not energized, the inlet valve is open and the outlet valve is closed. In the case of the “normally open” pressure control valve, the first spring 18 therefore preloads the armature 14 in the direction of the second valve seat 12, the second valve body 17 then sealing against the second valve seat 12 in the case of a de-energized magnet coil, that is to say when no magnetic forces act on the armature 14 (ventilating valve closed), and therefore prevents a ventilating operation, but the first body 16 lifts from the first valve seat (inlet valve open), in order to bring about aerating of the compressed air outlet connector 4.

In the case of an energization of the magnet core 20, in contrast, the armature 14 is actuated counter to the action of the spring force of the first spring 18 in such a way that the second valve body 17 is lifted from the second valve seat 12 (outlet valve open) and the first valve body 16 comes into sealing contact with the first valve seat 10 (inlet valve closed).

As an alternative, the electromagnetic pressure control valve might also be configured as a “normally closed” pressure control valve, in the case of which, when the magnet coil 20 is not energized, the inlet valve is closed and the outlet valve is open. In the case of an “normally closed” pressure control valve, the first spring 18 preloads the armature 14 in the direction of the first valve seat 10 in such a way that the first valve body 16 is loaded sealingly against the first valve seat 10 (inlet valve closed) and the second valve body 17 is lifted from the second valve seat 12 (outlet valve open) when the magnet coil 20 is de-energized and accordingly no magnetic forces act on the armature 14. In the case of an energization of the magnet core 20, the armature 14 is then actuated counter to the action of the spring force of the first spring 18 in such a way that the first valve body 16 is lifted from the first valve seat 10 (inlet valve open) and the second valve body 17 comes into sealing contact with the second valve seat 12 (outlet valve closed).

In the case of the two valve types, a permanent axial compressed air connection 25 through the first valve body 16, the armature 14 and the second valve body 17 is proposed, which compressed air connection 25 comprises the central axial through bore 15 of the armature 14, at least one first axial through opening 26 in the first valve body 16, and at least one second axial through opening 27 in the second valve body 17. Here, the first valve body 16 has a first radially inner portion 28 which closes the first valve seat 10 sealingly when the inlet valve is closed, and a first radially outer portion 29 which has the at least one first axial through opening 26. Furthermore, the second valve body 17 has a second radially inner portion 30 which closes the second valve seat 12 sealingly when the outlet valve is closed, and a second radially outer portion 31 which has the at least one second axial through opening 27.

The first radially outer portion 29 of the first valve body 16 with the at least one first axial through opening 26 and the second radially outer portion 31 of the second valve body 17 with the at least one second axial through opening 27 are therefore provided for axial compressed air routing along the permanent axial compressed air connection 25, but need not contribute to the closure of the first valve seat 10 and the second valve seat 12. In contrast, the first radially inner portion 28 of the first valve body 16 is provided to close the first valve seat 10, and the second radially inner portion 30 of the second valve body 17 is provided to close the second valve seat 12.

On account of this geometry, the permanent axial compressed air connection 25 therefore conducts compressed air from the compressed air supply connector 3 into the compressed air outlet connector 4, in particular, only when the inlet valve is open. When the inlet valve is closed, in contrast, the permanent axial compressed air connection 25 does not conduct any compressed air because firstly the first radially inner portion 28 of the first valve body 16 then closes the first valve seat 10 and, as a consequence, no compressed air can pass from the compressed air supply connector 3 into the permanent axial compressed air connection 25. Secondly, ventilation cannot be carried out either on account of the inlet valve of the compressed air supply connector 3 which is then closed.

Here, the first valve body 16 is, for example, a first separate body which is received in an axially displaceable or sliding manner, in particular, at the first end of the central axial through bore 15 of the armature 14. Here, the second valve body 17 is also a second separate body which is received, in particular, in an axially fixed and non-rotational manner in a second end of the axial through bore 15 of the armature 14, by virtue of the fact that it is held there by a press fit and/or a calked connection.

Here, the first valve body 16 which is mounted axially displaceably in the central axial through bore 15 of the armature 14 is supported axially on the second valve body 17 by way of a second spring 32 which preloads the first valve body 16 with its end surface which faces the first valve seat 10 against the radially inner collar 19 of the armature 14. The second spring 32 is supported on one side on an end surface of the first valve body 16 which points away from the first valve seat 10 and on the other side on a step 33 of the second valve body 17 which is, for example, of T-shaped configuration in cross section here and has a first cylindrical portion which points toward the first valve body 16 and has a diameter which is smaller than the diameter of a second cylindrical portion which makes contact with the radially inner circumferential surface of the central axial through bore 15 of the armature 14. There is therefore a radial annular gap 34 between the first portion with the smaller diameter and the radially inner circumferential surface of the central axial through bore 15 of the armature 14, in which annular gap 34 the second spring 32 is also arranged. This annular gap 34 configures, in particular, a portion of the permanent axial compressed air connection 25.

In particular, the first valve body 16 consists here exclusively of a first cylindrical sealing element 35 which, in its first radially outer portion 29, has radially outer grooves which are arranged, in particular, distributed on the circumference as first axial through openings 26 which run in the axial direction and serve for the axial compressed air routing, as shown in FIG. 2. The above-indicated at least one first axial through opening 26 is therefore formed here, for example, by way of the radially outer grooves which are arranged distributed on the circumference.

In an analogous way, the second radially outer portion 31 of the second valve body 17 has radially outer slots which are arranged, in particular, distributed on the circumference as second axial through openings 27, as is apparent from FIG. 1, which run in the axial direction and serve for the axial compressed air routing. The radially outer circumferential surface of the second valve body 17 which differs from the slots then makes contact with the radially inner circumferential surface of the central axial through bore 15 of the armature 14, here in the form of a press fit, for example. Here, the second valve body 17 may support a second flexible sealing element 36 which is made from an elastomer and seals against the second valve seat 12 when the outlet valve is closed. To this end, the second valve body 17 can be configured, in particular, as a compressed air-permeable cage, in which the second sealing element 36 is then held, the end surface of the second sealing element 36 which points toward the second valve seat 12 and interacts with the second valve seat 12 being released from the cage.

Against this background, the method of operation of the pressure control valve 1 is as follows:

In the de-energized state of the magnet coil, no magnetic force is exerted on the armature 14, as a result of which the pressure control valve 1 or the armature 14 then assumes the aerating position which is shown in FIG. 1 and in which the armature 14 is preloaded by way of the spring force of the first spring 18 in the direction of the second valve seat 12, downward in FIG. 1. The second valve body 17 and, more precisely, its central second sealing element 36 as second radially inner portion 30 is then seated on the second valve seat 12, as a result of which the outlet valve is closed and no ventilating can then take place either. Because in this position the at least one second axial through opening 27 of the second valve body (here, for example, in the form of the radially outer slots) is arranged radially on the outside in relation to the second radially inner portion 30 of the second valve body 17, no flow connection between the compressed air ventilating connector 5 and the compressed air outlet connector 4 is possible either.

Secondly, the inlet valve is then open, because the first valve body 16 is lifted from the first valve seat 10. As a result, compressed air which prevails at the compressed air supply connector 3, for example a brake pressure of a compressed air-actuated brake system of a vehicle, can pass via the stepped bore 9 to the first valve seat 10 and from there via the permanent axial compressed air connection 25, namely the radially outer grooves of the first sealing element 35, the annular gap 34 in the central axial through bore 15 of the armature 14, and the radially outer slots of the second valve body 17 to the compressed air outlet connector 4 and from there to a load, here, for example, to a diaphragm valve of a pressure control device for open loop or closed loop control of the brake pressure in a manner which is dependent on the brake slip.

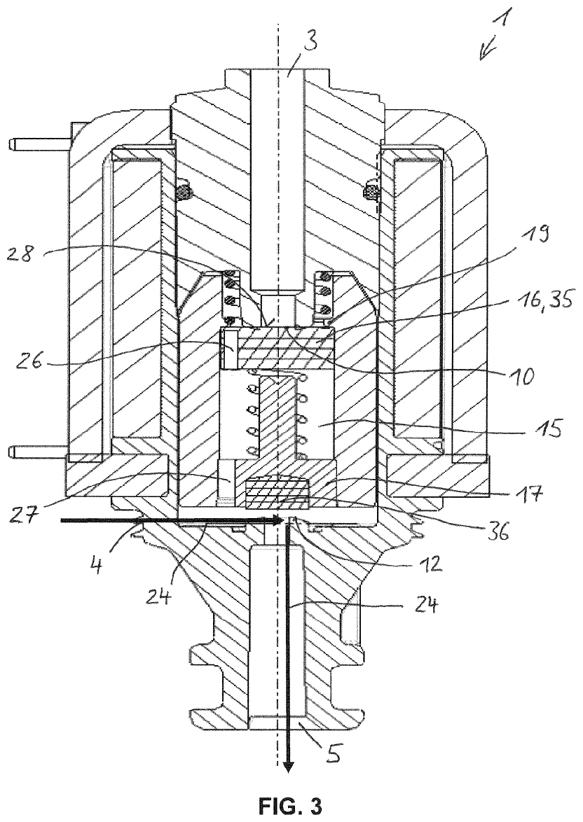

By way of electric excitation of the magnet coil 20 and the magnetic force which is generated as a result, the armature 14 is moved counter to the force of the first spring 18 along the longitudinal axis 6 in such a way that the electromagnetic pressure control valve 1 or the armature 14 assumes the ventilating position which is shown in FIG. 3 and in which the compressed air outlet connector 4 is connected to the compressed air ventilating connector 5. In detail, the first valve body 16 is then forced with its first radially inner portion 28 against the first valve seat 10 and closes the latter, with the result that compressed air can no longer continue to flow from the compressed air supply connector 3. Here, the first valve body 16 which is loaded by way of the spring force of the second spring 32 against the radially inner collar 19 can lift from the radially inner collar 19 and can move in the direction of the second valve body 17. In this way, the spring force of the second spring 32 which acts on the first valve body 16 mounted axially displaceably in the direction of the longitudinal axis 6, in combination with the elastic behavior of the first sealing element 35, ensures that an axial elasticity arises, by way of which the contact of the first valve body 16 or the first sealing element 35 with the first valve seat 10 is stabilized.

Because, in this position, the at least one first axial through opening 26 of the first valve body 16 (here, for example, in the form of the radially outer grooves) is arranged radially on the outside in relation to the first radially inner portion 28 of the first valve body 16, no flow connection between the compressed air supply connector 3 and the central axial through bore 15 of the armature 14 is possible.

In the case of the electromagnetic pressure control valve 1, the armature 14 can therefore be actuated axially in a manner which is dependent on an electric excitation or de-energization of the magnet core 20 between the aerating position, in which the second valve body 17 seals against the second valve seat 12, but the first valve body 16 is lifted from the first valve seat 10 (inlet valve open, outlet valve closed), and a ventilating position, in which the first valve body 16 seals against the first valve seat 10, but the second valve body 17 is lifted from the second valve seat 12 (inlet valve closed, outlet valve open).

As has already been indicated above, the pressure control valve 1 may be a constituent part of a pressure control valve device (otherwise not shown here) for a compressed air-actuated vehicle brake system which is configured, in particular, such that it controls a brake pressure in a manner which is dependent on brake slip, and which to this end comprises, apart from at least one above-described electromagnetic pressure control valve 1, at least one diaphragm valve which is pilot-controlled pneumatically by the electromagnetic pressure control valve 1.

In the case of the electromagnetic pressure control valve 1, the compressed air supply connector 3 is then connected to a device which generates (brake) pressure, for example to a foot brake valve, a foot brake module or to a pressure control module, the compressed air outlet connector 4 is connected to the pneumatically pilot-controllable diaphragm valve in order to pilot-control the diaphragm valve, and the compressed air ventilating connector 5 is connected to a pressure sink. The pressure which is output in a controlled manner by the electromagnetic pressure control valve 1 at its compressed air outlet connector 4 then acts, in particular, on a diaphragm of the diaphragm valve, in order to lift this diaphragm, for example, from a diaphragm valve seat or to load it sealingly against the diaphragm valve seat.

The excitation and de-energization of the magnet coil 20 then takes place, for example, by way of an electronic ABS control unit, in which ABS or brake slip control routines are implemented, in order to modulate the pressure output in a controlled manner at the compressed air outlet connector 4 in a manner which is dependent on brake slip, for example, by way of alternating actuating of the electromagnetic pressure control valve 1 from the ventilating position into the aerating position and vice versa, that is to say by way of repeated raising and lowering of the pressure.

### THE LIST OF DESIGNATIONS IS AS FOLLOWS

1 Pressure control valve
2 Housing
3 Compressed air supply connector
4 Compressed air outlet connector
5 Compressed air ventilating connector
6 Longitudinal axis
7 Blind bore
8 Insert
9 Stepped bore
10 First valve seat
11 Stepped bore
12 Second valve seat
13 Chamber
14 Armature
15 Central through bore
16 First valve body
17 Second valve body
18 First spring
19 Radially inner collar
20 Magnet coil
21 Radially outer recess
22 Magnet coil housing
23 Terminals
24 Arrows
25 Compressed air connection
26 First axial through opening
27 Second axial through opening
28 First radially inner portion
29 First radially outer portion
30 Second radially inner portion
31 Second radially outer portion
32 Second spring
33 Step
34 Annular gap
35 First sealing element
36 Second sealing element

1-13. (canceled)

14. An electromagnetic pressure control valve for controlling an air pressure, comprising:
(a) a housing having a compressed air supply connector for connection to a compressed air supply, a compressed air outlet connector for connection to a load, and a compressed air ventilating connector for ventilation;
(b) an armature which, on its end sides which face away from one another, supports in each case one valve body, a first valve body and a second valve body, and which can be displaced within the housing by magnetic forces counter to a spring force of at least one first spring, so that it connects the compressed air outlet connector selectively to the compressed air supply connector or the compressed air ventilating connector;
(c) a first valve seat connected to the compressed air supply connector;
(d) a second valve seat connected to the compressed air ventilating connector;
wherein:
(e) the first valve body forms, together with a first valve seat, an inlet valve, and the second valve body forming, together with the second valve seat, an outlet valve, including:
(f) a permanent axial compressed air connection through the first valve body, through the interior of the armature and through the second valve body, which compressed air connection includes at least one central axial through bore of the armature, at least one first axial through opening in the first valve body, and at least one second axial through opening in the second valve body,
wherein:
(g) the first valve body has a first radially inner portion which closes the first valve seat sealingly when the inlet valve is closed, and a first radially outer portion which has the at least one first axial through opening, and
(h) the second valve body has a second radially inner portion which closes the second valve seat sealingly when the outlet valve is closed, and a second radially outer portion which has the at least one second axial through opening.

15. The electromagnetic pressure control valve of claim 14, wherein the permanent axial compressed air connection conducts compressed air from the compressed air supply connector into the compressed air outlet connector when, in the case of an open inlet valve, the first valve body is lifted from the first valve seat and, in the case of a closed outlet valve, the second valve body is seated sealingly on the second valve seat.

16. The electromagnetic pressure control valve of claim 14, wherein the first valve body is a first separate body which is received within the central axial through bore of the armature.

17. The electromagnetic pressure control valve of claim 14, wherein the first valve body is received axially displaceably within the central axial through bore of the armature.

18. The electromagnetic pressure control valve of claim 14, wherein the second valve body is a second separate body and is received in an axially fixed and non-rotational manner in the central axial through bore of the armature.

19. The electromagnetic pressure control valve of claim 14, wherein the first valve body which is mounted axially displaceably in the central axial through bore of the armature is supported axially on the second valve body by at least one second spring.

20. The electromagnetic pressure control valve of claim 14, wherein the first valve body configures or supports a first flexible sealing element which is made from at least one elastomer and seals against the first valve seat when the inlet valve is closed.

21. The electromagnetic pressure control valve of claim 14, wherein the second valve body configures or supports a second flexible sealing element which is made from at least one elastomer and seals against the second valve seat when the outlet valve is closed.

22. The electromagnetic pressure control valve of claim 14, wherein the first radially outer portion of the first valve body and/or the second radially outer portion of the second valve body have/has at least one radially outer slot or at least one radially outer groove for axial compressed air routing.

23. The electromagnetic pressure control valve of claim 14, wherein at least one electric magnet coil is received in the housing, wherein the armature is actuatable axially in a manner which is dependent on an electric excitation or de-energization of the at least one magnet coil between a first axial position, in which the second valve body seals against the second valve seat and the first valve body is lifted from the first valve seat, and a second axial position, in which the first valve body seals against the first valve seat and the second valve body is lifted from the second valve seat.

24. The electromagnetic pressure control valve of claim 23, wherein the electromagnetic pressure control valve is configured as:
(a) a normally open pressure control valve, for which, when the magnet coil is not energized, the inlet valve is open and the outlet valve is closed, or
(b) a normally closed pressure control valve, for which, when the magnet coil is not energized, the inlet valve is closed and the outlet valve is open.

25. A pressure control valve apparatus for a compressed air-actuated vehicle brake system, comprising:
a pressure control valve device configured so that it controls a brake pressure in a manner which is dependent on brake slip;
at least one pneumatically pilot-controllable diaphragm valve
at least one electromagnetic pressure control valve, for which the compressed air supply connector is connected to a device which generates the brake pressure, the compressed air outlet connector being connected to the at least one pneumatically pilot-controllable diaphragm valve for pilot-controlling the at least one diaphragm valve, and the compressed air ventilating connector being connected to a pressure sink;
wherein the at least one electromagnetic pressure control valve includes:
(a) a housing having a compressed air supply connector for connection to a compressed air supply, a compressed air outlet connector for connection to a load, and a compressed air ventilating connector for ventilation;
(b) an armature which, on its end sides which face away from one another, supports in each case one valve body, a first valve body and a second valve body, and which can be displaced within the housing by magnetic forces counter to a spring force of at least one first spring, so that it connects the compressed air outlet connector selectively to the compressed air supply connector or the compressed air ventilating connector;
(c) a first valve seat connected to the compressed air supply connector;
(d) a second valve seat connected to the compressed air ventilating connector;
wherein:
(e) the first valve body forms, together with a first valve seat, an inlet valve, and the second valve body forming, together with the second valve seat, an outlet valve, including:
(f) a permanent axial compressed air connection through the first valve body, through the interior of the armature and through the second valve body, which compressed air connection includes at least one central axial through bore of the armature, at least one first axial through opening in the first valve body, and at least one second axial through opening in the second valve body,
wherein:
(g) the first valve body has a first radially inner portion which closes the first valve seat sealingly when the inlet valve is closed, and a first radially outer portion which has the at least one first axial through opening, and
(h) the second valve body has a second radially inner portion which closes the second valve seat sealingly when the outlet valve is closed, and a second radially outer portion which has the at least one second axial through opening.

26. A compressed air-actuated vehicle brake system, comprising:
at least one pressure control valve device, which is configured so that it controls a brake pressure in a manner which is dependent on brake slip, including:
at least one pneumatically pilot-controllable diaphragm valve;
at least one electromagnetic pressure control valve, for which the compressed air supply connector is connected to a device which generates the brake pressure, the compressed air outlet connector being connected to the at least one pneumatically pilot-controllable diaphragm valve for pilot-controlling the at least one diaphragm valve, and the compressed air ventilating connector being connected to a pressure sink;
wherein the at least one electromagnetic pressure control valve includes:
(a) a housing having a compressed air supply connector for connection to a compressed air supply, a compressed air outlet connector for connection to a load, and a compressed air ventilating connector for ventilation;
(b) an armature which, on its end sides which face away from one another, supports in each case one valve body, a first valve body and a second valve body, and which can be displaced within the housing by magnetic forces counter to a spring force of at least one first spring, so that it connects the compressed air outlet connector selectively to the compressed air supply connector or the compressed air ventilating connector;
(c) a first valve seat connected to the compressed air supply connector;
(d) a second valve seat connected to the compressed air ventilating connector;
wherein:
(e) the first valve body forms, together with a first valve seat, an inlet valve, and the second valve body forming, together with the second valve seat, an outlet valve, including:
(f) a permanent axial compressed air connection through the first valve body, through the interior of the armature and through the second valve body, which compressed air connection includes at least one central axial through bore of the armature, at least one first axial through opening in the first valve body, and at least one second axial through opening in the second valve body,
wherein:
(g) the first valve body has a first radially inner portion which closes the first valve seat sealingly when the inlet valve is closed, and a first radially outer portion which has the at least one first axial through opening, and
(h) the second valve body has a second radially inner portion which closes the second valve seat sealingly when the outlet valve is closed, and a second radially outer portion which has the at least one second axial through opening.
